(19) United States
(12) Patent Application Publication
(10) Pub. No.: US 2023/0123269 A1
(43) Pub. Date: Apr. 20, 2023

(54) MANAGEMENT SERVER, USER TERMINAL, GIFT SYSTEM, AND INFORMATION PROCESSING METHOD

(71) Applicant: DWANGO Co., Ltd., Tokyo (JP)

(72) Inventors: Takashi KOJIMA, Tokyo (JP); Kazuomi NIWA, Tokyo (JP)

(73) Assignee: DWANGO Co., Ltd., Tokyo (JP)

(21) Appl. No.: 17/796,240

(22) PCT Filed: Jan. 20, 2021
(86) PCT No.: PCT/JP2021/001800

§ 371 Date: Jul. 28, 2022

(30) Foreign Application Priority Data
Jan. 30, 2020 (JP) 2020-013849

(51) Int. Cl. H04N 21/2543; H04N 21/258; H04N 21/2187; H04N 21/239; G06Q 30/0207

(52) U.S. Cl. CPC H04N 21/2543; H04N 21/25866; H04N 21/2187; H04N 21/2393; G06Q 30/0207

(57) ABSTRACT

A gift system comprises a management server that manages gift submission requests submitted by a user during a live performance or live broadcast, and a user terminal operated by the user. The management server comprises a receiving unit that receives a gift submission request sent according to the actions of the user, a determining unit that compares the cumulative total for rewards when the gift submission request has been received with an upper limit to determine whether or not to accept the gift submission request, and a control unit that accepts the gift submission request in exchange for rewards according to the determination result of the determining unit. The user terminal comprises a detecting unit that detects a movement of the user terminal, and a transmitting unit that sends a gift submission request when the detecting unit has detected movement.

### TECHNICAL FIELD

The present invention relates to a management server, user terminal, gift system, and information processing method.

### BACKGROUND ART

Services that can deliver videos from live broadcasts using smartphones or personal computers have become popular. A service is known that allows viewers to post comments on the delivered videos and to submit gifts (sometimes called tossing coins, items, etc.).

Also, during performances at live venues, members of the audience can electronically send gifts from their smartphones.

### CITATION LIST

### Patent Literature

Patent Document 1: JP 6430059 B2

### SUMMARY OF INVENTION

### Technical Problem

If audience members could send gifts at live venues with a simple cheering action such as shaking a smartphone toward the stage, or could submit gifts while directing light from the smartphone screen toward the performance from their seats, audience satisfaction and the excitement of live performances could be improved.

However, if audience members keep shaking their smartphone throughout a live performance, there is a chance that the rewards paid by way of gifts will become excessive. However, if audience members have to check the amount paid while cheering, it will adversely affect audience satisfaction and take away from the excitement of live performances.

Patent Document 1 describes a technique for holding down excessive coin tossing by increasing the unit cost of coin tosses when the number of coin tosses exceeds an expected number. The technique in Patent Document 1 focuses on holding down coin tosses, but cannot hold down the amount paid by users.

In view of this situation, it is an object of the present invention to hold down rewards from gifts submitted by users during live performances and live broadcasts

### Solution to Problem

One aspect of the present invention is a gift system comprising a management server that manages gift submission requests submitted by a user during a live performance or live broadcast, and a user terminal operated by the user, wherein the management server comprises a receiving unit that receives a gift submission request sent according to the actions of the user, a determining unit that compares the cumulative total for rewards when the gift submission request has been received with an upper limit to determine whether or not to accept the gift submission request, and a control unit that accepts the gift submission request in exchange for rewards according to the determination result of the determining unit, the upper limit being set for each segment of a live performance or live broadcast divided based on at least one of a schedule, performer, performance, or predetermined time interval, and the determining unit comparing the cumulative total for rewards with the upper limit value for each segment, and the user terminal comprises a detecting unit that detects a movement of the user terminal, and a transmitting unit that sends a gift submission request when the detecting unit has detected movement.

### Effects of Invention

The present invention is able to hold down rewards from gifts submitted by users during live performances and live broadcasts.

### BRIEF DESCRIPTION OF DRAWINGS

FIG. 1 is a diagram showing an example of a configuration for the gift system in the first embodiment.

FIG. 2 is a diagram showing an example of a live performance while the gift system is being used.

FIG. 3 is a diagram showing an example of configurations for the management server and the user terminal.

FIG. 4 is a diagram showing an example of a table stored in the management server.

FIG. 5 is a diagram showing an example of a table stored in the management server.

FIG. 6 is a diagram showing an example of a table stored in the management server.

FIG. 7 is a flowchart showing the flow of operations performed during submission of a gift.

FIG. 8 is a diagram showing another example of configurations for the management server and the user terminal.

FIG. 9 is a flowchart showing the flow of operations performed during submission of a gift in the modified example.

### DESCRIPTION OF EMBODIMENTS

### System Configuration

An embodiment will now be described with reference to the drawings.

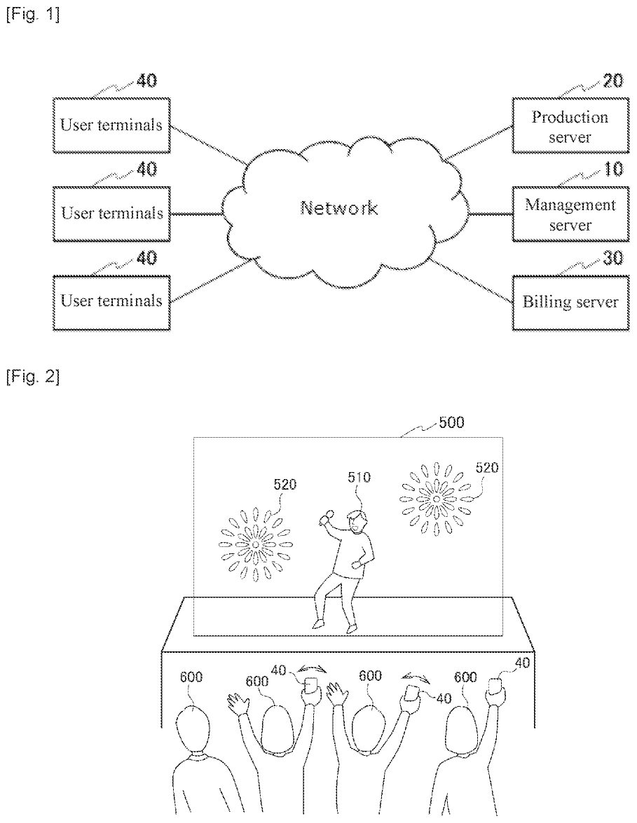

FIG. 1 is a diagram showing an example of a configuration for the gift system in the present embodiment. The gift system in the present embodiment is a system for managing gifts submitted by users during a live performance or live broadcasting. The gift system shown in the figure includes a management server 10, a production server 20, a billing server 30, and user terminals 40. These devices are connected via a network.

The management server 10 receives a gift submission request sent from a user terminal 40, accepts gift submission request in exchange for rewards, and adds an effect based on the gift submission request to the live venue or the live broadcast video. The rewards may be real money or points purchased in advance by the user. By submitting gifts (sometimes called tossing coins, items, etc.), users can enhance live performances and live broadcasts and support performers and distributors. Revenue from gifts can be distributed to live performance performers or live broadcast distributors.

The management server 10 sets an upper limit on rewards paid by each user or by all users, and accepts gift submission requests when the cumulative total for rewards paid does not exceed an upper limit, and rejects gift submission requests when the upper limit has been exceeded. In this way, the user can continue participating at a live concert or watch a live broadcast while preventing excessive spending by users.

The production server 20 adds production value based on gift submission requests received by the management server 10 at a live venue or a live broadcast video. The production server 20 may change production values based on rewards from gifts.

For example, during a live performance, the production server 20 may display the image of the submitted gift on a screen installed at the live venue, control the lighting at the live venue to add production value, or add production value with sound. Alternatively, the production server 20 may add a score based on submitted gifts, and add an effect when the score exceeds a predetermined threshold value. The production server 20 may also add production value to a user terminal 40. For example, a predetermined image may be displayed on the screen of the user terminal 40 that the user is shaking at the live venue.

During a live broadcast, the production server 20 superimposes a gift image or adds sound to the live broadcast video that is distributed. When a live broadcast program occurs in a three-dimensional virtual space, the production server 20 may cause a gift icon corresponding to a submitted gift to appear in the virtual space.

The billing server 30 bills the user for rewards based on gift submission requests received by the management server 10. For example, the billing server 30 may deduct points equivalent to the rewards based on gift submission requests from the balance of points purchased in advance by the user. The billing server 30 notifies the management server 10 that the payment process has been completed, and the management server 10 issues an instruction to the production server 20 to add production value based on the gift submission request. When the point balance is insufficient, the billing server 30 notifies the management server 10 that the payment process has failed, and the management server 10 rejects the gift submission request and notifies the user terminal 40 that the payment processing has failed.

The user terminal 40 can be any terminal used to liven up a live concert or send a gift submission request. For example, a predetermined application can be started on a user smartphone so that the smartphone can be used as a user terminal 40. The user can liven up a live performance by shaking the user terminal 40 with the screen lighting up the live venue. The user can also operate the user terminal 40 to send a gift submission request to the management server 10. For example, when users swing their arms, raise their arms up, or jump while holding a user terminal 40 at a live venue, the user terminals 40 detect the users' movements and sends gift submission requests to the management server 10. In other words, when users cheer the performer or enliven the live performance while holding their user terminals 40, the user terminals 40 detect these movements and send gift submission requests to the management server 10.

When watching a live broadcast at home, the device used to watch the live broadcast can be used by the user as the user terminal 40. For example, the user can send a gift to the live broadcast distributor using the keyboard of the user terminal 40 or activate a gift submission icon displayed on the screen. When sending a gift, the user may add a comment to be superimposed on the live video. Users can send comments to liven up live broadcasts while submitting gifts. Even when watching a live broadcast at home, a gift submission request may be sent by using a smartphone as the user terminal 40. Here, the user holds the user terminal 40 and performs a predetermined action.

In both cases, the user can submit gifts while enlivening live concerts and live broadcasts.

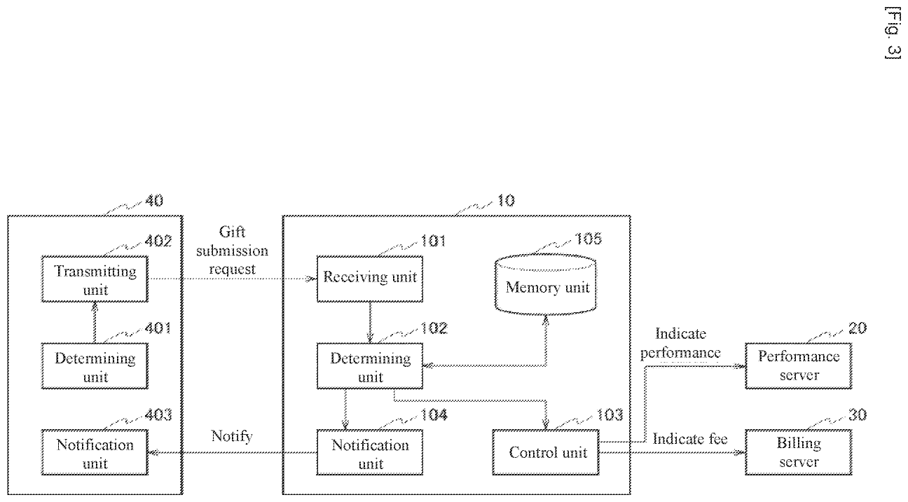

FIG. 2 is a diagram showing an example of a live performance while the gift system is being used. In the example shown in FIG. 2, a transparent screen 500 is placed on the stage at a live venue, and a live performance is performed by a performer 510 rendered using computer graphics (CG). The movement of the performer 510 is controlled in real time by stagehands or staff at a separate studio. The songs and conversations by the performer 510 are performed in real time by staff.

The audience members (users) 600 cheer the performer 510 projected on the transparent screen 500 from their seats at the live venue. The smartphones held by audience members 600 are activated as user terminals 40. When audience members 600 shake their user terminal 40 while cheering the performer 510, the user terminals 40 detect the movements of audience members 600 and send gift submission requests.

When a gift is sent from audience members 600, production value based on these gifts is added on the transparent screen 500. In the example shown in FIG. 2, an image of fireworks 520 is rendered on the transparent screen 500 based on gift submissions.

### Device Configurations

The configurations of the management server 10 and a user terminal 40 will now be described with reference to FIG. 3. The management server 10 shown in the figure includes a receiving unit 101, a determining unit 102, a control unit 103, a notification unit 104, and a memory unit 105. The user terminal 40 includes a detecting unit 401, a transmitting unit 402, and a notification unit 403. Both the management server 10 and the user terminal 40 can be general-purpose computer systems with a central processing unit (CPU), memory, storage, communication functions, and input/output functions. In these computer systems, the management server 10 and the user terminal 40 are realized when their CPUs execute predetermined programs loaded in their memories. These programs can be recorded on a computer-readable recording medium such as a magnetic disk, an optical disk, or a semiconductor memory and distributed, or can be distributed via a network. The management server 10 can also be realized by a plurality of computers or by a virtual machine in the cloud. The management server 10 may perform the functions of both the performance server 20 and the billing server 30.

Each component of the user terminal 40 will be described first.

The detecting unit 401 detects movement by the user terminal 40 using, for example, an acceleration sensor or a gyro sensor. When the detecting unit 401 detects a predetermined movement, it determines that the user has performed a predetermined action, and instructs the transmitting unit 402 to transmit a gift submission request. The detecting unit 401 may detect a predetermined action based on an operation performed on a touch panel included in the user terminal 40.

The transmitting unit 402 transmits the gift submission request to the management server 10 based on instructions from the detecting unit 401. The gift submission request may include a user ID for identifying the user, the type of gift that has been submitted, and/or information on composition in exchange for the gift.

The notification unit 403 sends notifications to the user from the management server 10. For example, the notification unit 403 vibrates the user terminal 40, lights up the screen, or makes a sound when notification is given that a gift submission request has been accepted or rejected. The notification unit 403 may display a notification message from the management server 10 on the screen. Examples of messages displayed by the notification unit 403 may include: “the upper limit for gifts that can be submitted has been reached,” “you do not have enough points left to submit a gift,” and “a gift has been submitted”. By sending a notification message to the user, the user can be prompted to take action such as changing the setting for the upper limit value or purchasing additional points. The notification unit 403 may vibrate the user terminal 40 using a vibration pattern that is different for each notification message. For example, the notification unit 403 vibrates the user terminal 40 once when a gift submission request has been rejected, and vibrates the user terminal 40 twice when a gift submission request has been accepted. The notification unit 403 may use vibrations, sounds, and screen displays to communicate different notification messages. For example, the notification unit 403 can vibrate the user terminal 40 when a gift submission request has been rejected, output a sound when the upper limit has been released, and turn the screen on and off when a gift submission request has been accepted.

Each component of the management server 10 will now be described.

The receiving unit 101 receives a gift submission request from a user terminal 40.

The determining unit 102 compares the cumulative total for rewards if the received gift submission request is accepted with the preset upper limit value to determine whether or not to accept the gift submission request. Specifically, the determining unit 102 adds rewards for the gift submission request received so far to the cumulative rewards for received gift submission requests, and compares the cumulative total value with the upper limit value. The determining unit 102 determines that the gift submission request has been accepted when the cumulative total value does not exceed the upper limit value, and determines that the gift submission request has been rejected when the cumulative total value exceeds the upper limit value. The determining unit 102 may compare the cumulative total for rewards to the upper limit value of each user, or may compare the cumulative total for rewards to the upper limit value for all users. The determining unit 102 may compare the cumulative total for rewards during each predetermined time interval with the upper limit value.

When the determining unit 102 has determined that the gift submission request has been accepted, the control unit 103 has the billing server 30 charge the user for rewards based on the gift submission request and has the performance server 20 add performance value in response to the gift submission request.

When the determining unit 102 determines that the gift submission request has been rejected, the notification unit 104 notifies the user terminal 40 that the gift submission request has been rejected. The notification unit 104 may also notify the user terminal 40 that the cumulative total for rewards has reached the upper limit value, or may notify the user terminal 40 that a gift submission request is acceptable. The notification unit 104 may also notify the user terminal 40 that a gift submission request has been accepted.

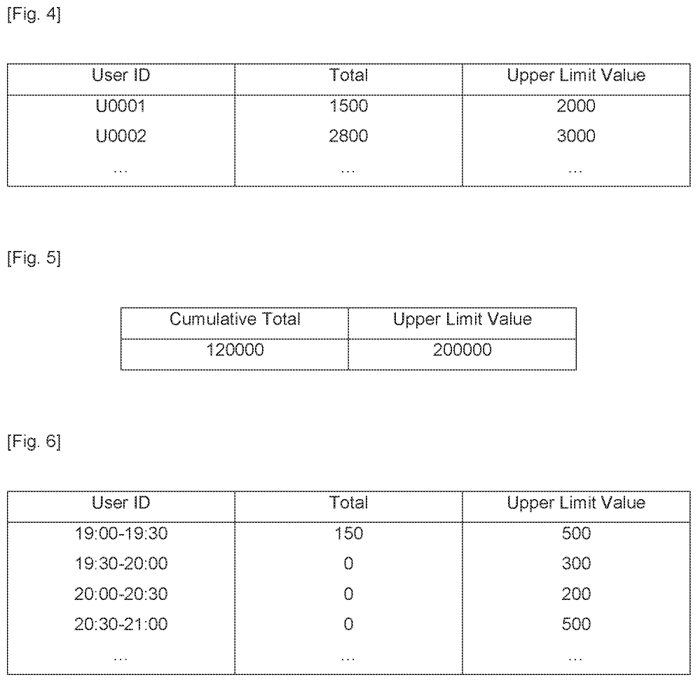

The memory unit 105 stores the cumulative total and the upper limit for rewards paid so far. For example, as shown in FIG. 4 to FIG. 6, the memory unit 105 stores the upper limit value set for each user, the upper limit value set for all users, or the upper limit value set for each time interval. In the example shown in FIG. 4, the cumulative total and the upper limit for rewards from received gift submission requests are stored for each user. In the example shown in FIG. 5, the cumulative total and the upper limit for rewards from received gift submission requests are stored for all users. In the example shown in FIG. 6, the cumulative total and the upper limit for rewards from received gift submission requests are stored for each time interval. The upper limit value for each time interval in FIG. 6 may be set for each user or for all users. The upper limit values for each user may be set after setting the upper limit value for all users.

The upper limit value may be set in advance by the user or may be set by the system (organizer).

### Gift Submission Processing

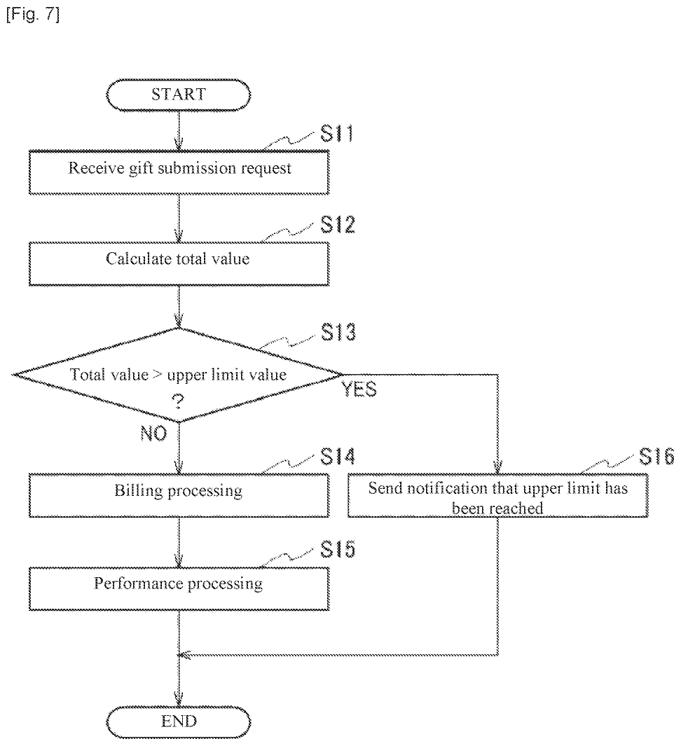

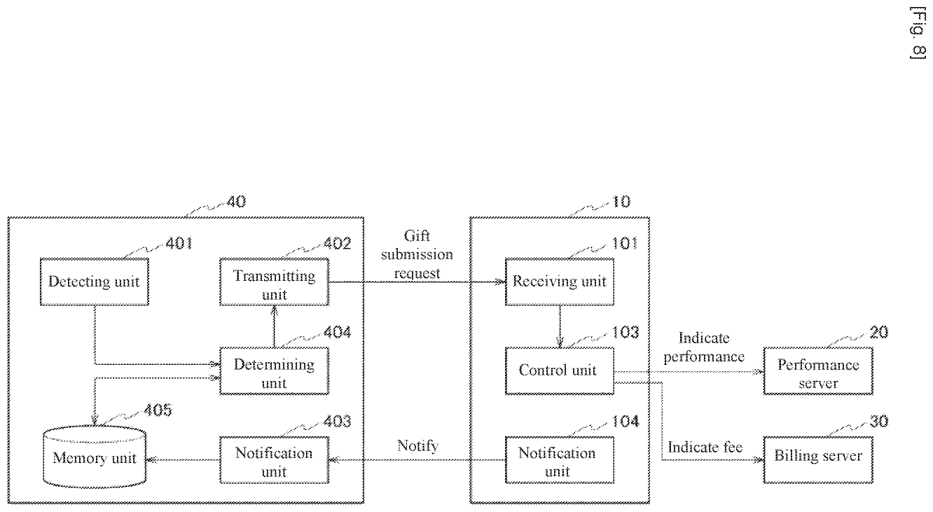

The processing performed by the management server 10 will now be described with reference to the flowchart in FIG. 7.

In step S11, the receiving unit 101 receives a gift submission request from a user terminal 40. The receiving unit 101 may extract a user ID, the gift type, and rewards information from the received gift submission request.

In step S12, the determining unit 102 determines the total value by adding the rewards from the received gift submission request to the cumulative total for rewards consideration paid so far, and in step S13, determines whether or not the cumulative total value exceeds the upper limit.

For example, when the upper limit value is set for each user, the determining unit 102 acquires the cumulative total for rewards from the user who sent the gift submission request from the table shown in FIG. 4, and adds rewards for the gift submission request to the cumulative total to obtain the total value. The determining unit 102 compares the total value with the upper limit value for the user in the table shown in FIG. 4. If the total value does not exceed the upper limit value, the determining unit 102 determines that the gift submission request has been accepted, updates the cumulative total for rewards in the table shown in FIG. 4 by the total value, and proceeds to step S14. If the total value exceeds the upper limit, the determining unit 102 determines that the received gift submission request has been rejected, and proceeds to step S16.

When the upper limit value has been set for all users, the determining unit 102 acquires the cumulative total for rewards from the table shown in FIG. 5, and adds the rewards for the gift submission request to the cumulative total to calculate the total value. Here, the cumulative total is the cumulative total for rewards paid by all users. The determining unit 102 compares the total value with the upper limit value in the table shown in FIG. 5. If the total value does not exceed the upper limit value, the determining unit 102 determines that the gift submission request has been accepted, updates the cumulative total for rewards in the table shown in FIG. 5 with the total value, and proceeds to step S14. If the total value exceeds the upper limit, the determining unit 102 determines that the received gift submission request has been rejected, and proceeds to step S16.

When the upper limit value has been set for each time interval, the determining unit 102 acquires the cumulative total for rewards at the present time from the table shown in FIG. 6, and adds the rewards for the gift submission request to the cumulative total to calculate the total value. The determining unit 102 compares the total value with the upper limit value in the table shown in FIG. 6. If the total value does not exceed the upper limit value, the determining unit 102 determines that the gift submission request has been accepted, updates the cumulative total for rewards in the table shown in FIG. 6 with the total value, and proceeds to step S14. If the total value exceeds the upper limit, the determining unit 102 determines that the received gift submission request has been rejected, and proceeds to step S16.

When a plurality of conditions have been combined, the determining unit 102 determines that the gift submission request has been rejected if the total value exceeds the upper limit under any of the conditions. For example, when an upper limit has been set for each user and an upper limit set has been set for all users and a user has sent a gift submission request, the request cannot be submitted even if the cumulative total for rewards from the user has not reached its upper limit, if the cumulative total for rewards from all users has reached its upper limit.

Alternatively, when a plurality of conditions have been combined, the determining unit 102 may determine that a gift submission request has been rejected if the total value exceeds the upper limit under all of the conditions.

When the determining unit 102 has determined that a gift submission request has been accepted, the control unit 103 sends an instruction to the buffing server 30 to charge rewards in response to the gift submission request in step S14, and send an instruction to create production value based on the gift submission request to the production server 20 in step S15.

When the determining unit 102 has determined that a gift submission request has been rejected, the notification unit 104 notifies the user terminal 40 in step S16 that the cumulative total for paid rewards has reached its upper limit and the gift input request has been rejected. When a gift submission request has been accepted, the notification unit 104 may notify the user terminal 40 that the gift submission request has been accepted.

### Modified Example

The following is a description of a gift system in a modified example. In the gift system in the modified example, the user terminal 40 determines whether or not to send a gift submission request.

The configurations of the management server 10 and the user terminal 40 in the modified example will now be described with reference to FIG. 8. The management server 10 shown in the figure includes a receiving unit 101, a control unit 103, and a notification unit 104. The user terminal 40 includes a detecting unit 401, a transmitting unit 402, a notification unit 403, a determining unit 404, and a memory unit 405. The management server 10 and the user terminal 40 shown in FIG. 8 may have the same functions as those shown in FIG. 3.

Each component of the user terminal 40 will be described first.

The detecting unit 401 detects movement by the user terminal 40 using, for example, an acceleration sensor or a gyro sensor. When the detecting unit 401 detects a predetermined movement, it notifies the determining unit 404.

The determining unit 404 determines whether or not to send a gift submission request based on the cumulative total for rewards paid. Specifically, the determining unit 404 compares the cumulative total for rewards if the gift submission request were to be sent with the upper limit value to determine whether or not to send the gift submission request. The cumulative total for rewards paid so far and the upper limit may be stored in the memory unit 405 or may be requested from the management server 10. The determining unit 404 may determine whether or not to send a gift submission request based on the overall total for rewards from all users, or may determine whether or not to send a gift submission request based on the cumulative amount of rewards for each time interval.

The transmitting unit 402 sends the gift submission request to the management server 10 based on the determination results of the determining unit 404. Specifically, if the total amount of rewards paid has not reached the upper limit, the gift submission request is sent to the management server 10.

The memory unit 405 stores the information needed in the determination processing performed by the determining unit 404. Specifically, the memory unit 405 stores the cumulative total and the upper limit for rewards paid by the user. The cumulative total and the upper limit for each time interval shown in FIG. 6 may be stored. When the upper limit value is set for all users, the memory unit 405 may acquire and store the cumulative total for rewards paid by all users and the upper limit value from the management server 10.

The notification unit 403 receives the gift submission results and notifies the user of the gift submission results. The notification unit 403 may receive the cumulative total for rewards paid by the user so far and store it in the memory unit 405.

Next, each component of the management server 10 in the modified example will be described.

The receiving unit 101 receives a gift submission request from a user terminal 40.

The control unit 103 notifies the billing server 30 of the rewards based on the gift submission request to bill the user, and has the production server 20 add production value in response to the gift submission request.

The notification unit 104 sends notification of the gift submission results and the cumulative total for rewards paid so far.

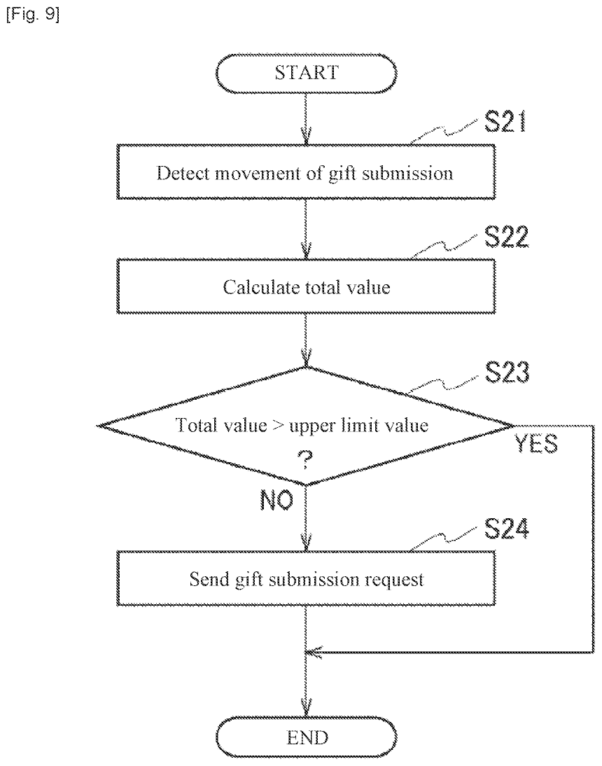

The processing performed by the user terminal 40 in the modified example will now be described with reference to the flowchart in FIG. 9.

In step S21, the detecting unit 401 detects that the user has performed a predetermined action from movement of the user terminal 40.

In step S22, the determining unit 404 obtains the total value by adding rewards based on the gift submission request to be sent to the cumulative total for rewards paid so far.

In step S23, the determining unit 404 determines whether or not the total value exceeds the upper limit value.

If the total value does not exceed the upper limit, the transmitting unit 402 sends the gift submission request to the management server 10 in step S24.

If the total value exceeds the upper limit, the process ends. The notification unit 403 may detect the action of submitting a gift, but inform the user that the gift submission request has not been sent because the total rewards paid has reached the upper limit.

### Another Modified Example

A condition indicating whether or not a target in a performance can receive gifts may be added to the conditions for accepting gift submission requests in the management server 10 in FIG. 3 or the conditions for accepting gift submission requests in the user terminal 40 in FIG. 8. The management server 10 stores the subject of user gifts. A target of user gifts may be a performer supported by the user, the user's favorite song, or the time period in which a performer supported by the user appears. Information on performers and songs currently being performed is entered in the management server 10 by the staff. The management server 10 compares the target currently performing with the targets of user gifts, and rejects gift requests if the target currently performing is not included among the gift targets of the user who sent the gift request. Gift submission requests may include information about gift targets.

Similar processing can be performed by the user terminal 40 to determine whether or not to send a gift submission request based on gift targets. The user terminal 40 stores gift targets, receives information on the target currently performing from the management server 10, and compares the target currently performing with user gift targets to determine whether to send a gift submission request.

As explained above, the gift system in the present embodiment comprises a management server 10 that manages gift submission requests submitted by a user during a live performance or live broadcast, and a user terminal 40 operated by the user. The management server 10 comprises a receiving unit 101 that receives a gift submission request sent according to the actions of the user, a determining unit 102 that compares the cumulative total for rewards when the gift submission request has been received with an upper limit to determine whether or not to accept the gift submission request, and a control unit 103 that accepts the gift submission request in exchange for rewards according to the determination result of the determining unit 102. The user terminal 40 comprises a detecting unit 401 that detects a movement of the user terminal, and a transmitting unit 402 that sends a gift submission request when the detecting unit 401 has detected movement. In this way, users can submit gifts by shaking user terminals 40 toward the stage to liven up a live performance without worrying about rewards paid. Because money used in live performances can be held down, the financial burden on users can be reduced and continued participation ensured.

### REFERENCE SIGNS LIST

10: Management server

101: Receiving unit

102: Determining unit

103: Control unit

104: Notification unit

105: Memory unit

40: User terminal

401: Detecting unit

402: Transmitting unit

403: Notification unit

404: Determining unit

405: Memory unit

1. A management server configured to manage gift submission requests submitted by a user during live performances or live broadcasts, the management server comprising:
a receiving unit configured to receive a gift submission request sent according to the actions of the user;
a determining unit configured to compare a cumulative total for rewards when the gift submission request has been received with an upper limit to determine whether or not to accept the gift submission request; and
a control unit configured to accept the gift submission request in exchange for rewards according to the determination result of the determining unit.

2. The management server according to claim 1, wherein the determining unit is configured to compare the cumulative total for rewards with the upper limit value for each user.

3. The management server according to claim 1, wherein the determining unit is configured to compare the cumulative total for rewards with the upper limit value for all users.

4. The management server according to claim 1, further comprising a production unit configured to add a predetermined effect to the live performance or live broadcast when a gift submission request is accepted.

5. The management server according to claim 1, further comprising a notification unit configured to notify the user that the gift submission request has been rejected or that the gift submission request can be accepted.

6. A user terminal configured to that send a gift submission request to a management server, the user terminal comprising:
a detecting unit configured to detect a movement of the user terminal; and
a transmitting unit configured to send a gift submission request when the detecting unit has detected movement.

7. The user terminal according to claim 6, further comprising a notification unit configured to notify a user in a mode based on the content of the notification when a notification has been received from the management server.

9. An information processing method for managing a gift submission request submitted by a user during a live performance or live broadcast, the information processing method comprising:
receiving a gift submission request sent according to the actions of the user;
compares a cumulative total for rewards when the gift submission request has been received with an upper limit to determine whether or not to accept the gift submission request; and
accepting the gift submission request in exchange for rewards according to the determination result of the determining unit, wherein.
